(19) United States
(12) Patent Application Publication
(10) Pub. No.: US 2017/0264545 A1
(43) Pub. Date: Sep. 14, 2017

(54) PACKET PROCESSING APPARATUS AND TABLE SELECTION METHOD

(71) Applicant: FUJITSU LIMITED, Kawasaki-shi (JP)

(72) Inventor: Kazuto Nishimura, Yokohama (JP)

(73) Assignee: FUJITSU LIMITED, Kawasaki-shi (JP)

(21) Appl. No.: 15/449,381

(22) Filed: Mar. 3, 2017

(30) Foreign Application Priority Data
Mar. 10, 2016 (JP) 2016-046705

(51) Int. Cl. H04L 12/743; H04L 12/851; H04L 12/741

(52) U.S. Cl. CPC H04L 45/7457; H04L 45/54; H04L 47/2483; H04L 47/2441

(57) ABSTRACT

An apparatus includes a memory storing a table including packet identification information and information indicating a process corresponding to the packet identification information, a unit to search for a process corresponding to packet identification information of a received packet from the table, a unit to acquire table candidates that have different types and in which all packets identified by new identification information for a packet and existing identification information for a packet are retrievable from the table candidates, based on the existing packet identification information and the new packet identification information when a addition request of a new entry including the new identification information for a packet is received, and a unit to select a table used for a search among the table candidates based on the number of packet identification information stored in each of the table candidates.

### CROSS-REFERENCE TO RELATED APPLICATION

This application is based upon and claims the benefit of priority of the prior Japanese Application No. 2016-046705 filed on Mar. 10, 2016, the entire contents of which are incorporated herein by reference.

### FIELD

The present invention relates to a packet processing apparatus and a table selection method.

### BACKGROUND

Software Defined Networking (SDN) is a technique for controlling the behavior of the overall network by software. OpenFlow technology is available as a standard for implementing SDN. An OpenFlow network includes an OpenFlow switch (OF-SW, which hereinafter may also be called a “switch”) that has a data forwarding function and an OpenFlow controller (OFC, which hereinafter may also be called a “controller”) that is responsible for route control. The controller and the switch communicate in accordance with the OpenFlow protocol.

Each switch includes a flow table storing a piece of information for determining an operation (action) on a packet input to the switch itself. In OpenFlow, communication traffic is controlled in communication units called “flows”. A flow includes components, header fields (also called match criteria), an action, and statistics. A flow table is a collection of entries (hereinafter called “flow entries”), each of which stores a piece of information on a flow. Each flow entry includes header fields (also called match criteria), an action, and statistics.

Match criteria are a piece of packet (traffic) identification information and are formed from parameters for finding out a packet. Match criteria are formed from any combination of pieces of header information (a MAC (Media Access Control) address, a VLAN (Virtual Local Area Network) tag, an IP (Internet Protocol) address, a TCP/UDP port number, and the like) of a packet. An action is a piece of information indicating processing details (an operation or action) on a packet matching the match criteria. Statistics indicate statistics like the number of packets matching the match criteria and subjected to a process based on the action. A switch can refer to a flow table, find out an entry including match criteria which a received packet matches, and perform an action (e.g., outputting the packet through a given port) defined in the found-out entry.

A piece of information on a flow (a flow entry) is generated by a controller and is transmitted to each switch using the OpenFlow protocol. Each switch stores a flow received from the controller in a flow table. As described above, the controller manages flow tables of switches under the command of the controller itself in an integrated manner.

For further information, see Japanese Laid-Open Patent Publication No. 11-17704, Japanese Laid-Open Patent Publication No. 2015-186213, and Japanese National Publication of International Patent Application No. 2014-506409.

### SUMMARY

One of aspects of the present invention is a packet processing apparatus. The packet processing apparatus includes a memory storing a table including a piece of packet identification information and a piece of information indicating a process corresponding to the piece of packet identification information, a processing unit configured to search for a process corresponding to a piece of packet identification information of a received packet from the table, an acquisition unit configured to acquire a plurality of table candidates that have different types and in which all packets identified by a new piece of identification information for a packet and an existing piece of identification information for a packet are retrievable from the plurality of table candidates, based on the existing piece of packet identification information and the new piece of packet identification information when a request for addition of a new entry including the new piece of identification information for a packet is received, and a selection unit configured to select a table used for a search by the processing unit from among the plurality of table candidates based on a number of pieces of packet identification information stored in each of the plurality of table candidates.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a diagram illustrating an example of a network system according to an embodiment;

FIG. 2A schematically illustrates a flow table in OpenFlow ver. 1.0;

FIG. 2B schematically illustrates a flow table in OpenFlow ver. 1.1;

FIG. 3 is an explanatory diagram according to the embodiment;

FIG. 4 is an explanatory diagram according to the embodiment;

FIG. 5 illustrates an example of the hardware configuration of an information processing apparatus (computer) which can be used as each of a controller and switches;

FIG. 6 is a diagram schematically illustrating functions of a switch (OF-SW);

FIG. 7 is a diagram schematically illustrating functions related to flow table creation of the switch (OF-SW);

FIG. 8 illustrates an example of the data structure of a predicted time database;

FIG. 9 illustrates an example of a configuration according to another embodiment of the switch;

FIG. 10 is a flowchart illustrating an example of a table type (candidate) determination process to be performed by a table analysis and selection unit;

FIG. 11 is an explanatory diagram of the table type “sequential search with mask”;

FIG. 12 is an explanatory diagram of a table of “tree type mask”;

FIG. 13 is an explanatory diagram of the table type “hash type EM”;

FIG. 14 is an explanatory diagram of the table type “few-entry type EM”;

FIG. 15 is an explanatory diagram of the table type “multistage EM”;

FIG. 16 is an explanatory diagram of the table type “sequential search with mask plus cache system”;

FIG. 17 is a graph illustrating the relationship between the number of entries and a predicted required time for each of a plurality of table types and illustrates an example of the content of data stored in the predicted time database;

FIG. 18 is a flowchart illustrating an example of a process by a performance knowledge accumulation unit;

FIG. 19 is a flowchart illustrating an example of a table type change process;

FIG. 20 is an explanatory diagram of table change; and

FIG. 21 is an explanatory diagram of table addition.

### DETAILED DESCRIPTION OF EMBODIMENT

A packet processing apparatus and a table selection method thereof relating to an embodiment will be described below with reference to the drawings. A configuration of the embodiment is a mere example, and the present invention is not limited to the configuration of the embodiment.

In general, performance (retrieval (search) speed and scalability) decreases with an increase in the flexibility of a flow table (an allowable range for registration in the flow table). One of flexible search methods is a search with mask. In the search with mask, whether to refer to can be freely set for, for example, each of a plurality of parameters set as match criteria or each bit or byte of each parameter.

For example, if a MAC address and an IP address can be set as a search target, one of the MAC address and the IP address may be masked. Alternatively, a search target having a prefix like an IP address may be set as a match criterion. Assume a case where an entry, an IP address of which is set as a match criterion, is registered. An IP address exclusive of a prefix needs no reference and can be masked. The size of a prefix can be appropriately set. It is thus conceivable to prepare a table for the search with mask as a flow table to allow search across a plurality of entries different in prefix (different in mask position) in the one table.

The search with mask, however, performs sequential search across individual entries, which results in a lower retrieval speed. A time for search in such a table may affect packet forwarding processing to cause a reduction in packet throughput in a switch. It is an object of the embodiment to provide a technique capable of suppressing a lowering of retrieval speed of a table.

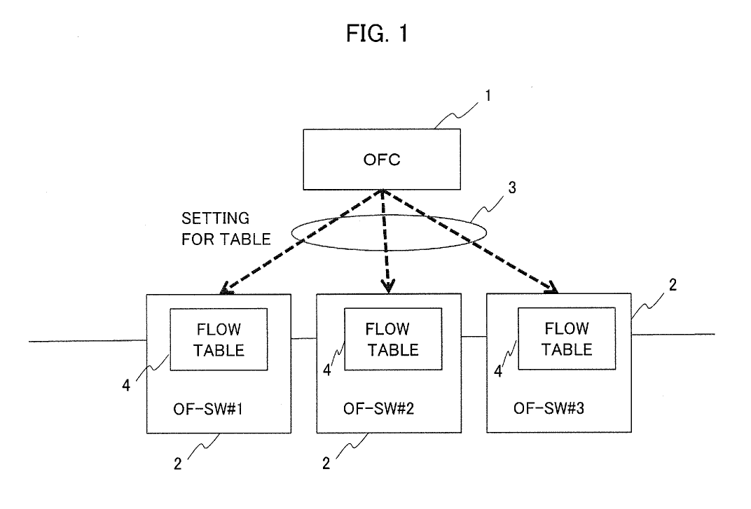

FIG. 1 is a diagram illustrating an example of a network system according to the embodiment. An OpenFlow network system is illustrated as an example of an SDN network system in FIG. 1. Note that OpenFlow is an example of SDN and that the configuration according to the embodiment can be applied to an SDN system other than OpenFlow.

In the example illustrated in FIG. 1, the OpenFlow network includes a controller (OFC) 1 and a plurality of switches (OF-SW) 2 that are connected to the OFC 1 via a network 3. In the example in FIG. 1, OF-SW #1, OF-SW #2, and OF-SW #3 are illustrated as the plurality of switches.

The OFC 1 communicates with each OF-SW 2 using the OpenFlow protocol and controls the operation of the OF-SW 2. For example, when a packet is forwarded by a route from OF-SW #1 to OF-SW #2 to OF-SW #3, the OFC 1 makes a flow entry for each OF-SW 2 and transmits the flow entry to the corresponding OF-SW 2.

In the example, the OFC 1 makes, for OF-SW #1, a flow entry including match criteria, by which a packet (traffic) as a forwarding target is found out, and an action of outputting the packet as the target to a port connected to OF-SW #2. The OFC 1 transmits the flow entry to OF-SW #1. The OFC 1 makes, for OF-SW #2, a flow entry for outputting the packet received from OF-SW #1 through a port connected to OF-SW #3 and transmits the flow entry to OF-SW #2. The OFC 1 makes, for OF-SW #3, a flow entry for outputting the packet received from OF-SW #2 through a predetermined port and transmits the flow entry to OF-SW #3.

Each OF-SW 2 stores a flow entry received from the OFC 1 in a flow table 4. Upon receipt of a packet, each OF-SW 2 finds out a flow entry having match criteria which match the packet and performs an operation in accordance with a piece of action information in the found-out flow entry. With this operation, the received packet is output through a specified port in accordance with the piece of action information.

The OFC 1 controls the operation of the OF-SWs 2 by controlling flow entries transmitted to the OF-SWs 2 in an integrated manner. When a packet which does not match any of flow entries (match criteria) stored in the flow table 4 is received, the OF-SW 2 transmits a message of request for provision of a flow entry corresponding to the packet to the OFC 1. The OFC 1 makes a corresponding flow entry and transmits the flow entry to the OF-SW 2 in response to the message of request for provision.

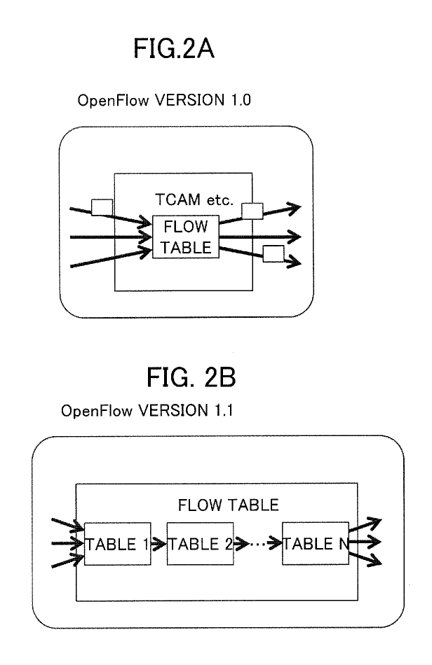

The flow table 4 that stipulates operations of the OF-SW 2 is formed from flow entries received from the OFC 1. FIG. 2A schematically illustrates a flow table in OpenFlow ver. 1.0 while FIG. 2B schematically illustrates a flow table in OpenFlow ver. 1.1. In OpenFlow ver. 1.0, one flow table is provided in the OF-SW 2, and match criteria have 12 elements (fields of retrieval targets), as illustrated in FIG. 2A.

The elements (fields of retrieval targets) are a receiving port (Switch Port (Ingress Port)), a source MAC address (MAC src), a destination MAC address (MAC dst), a protocol type, a VLAN-ID, a VLAN priority (a VLAN PCP (Priority Code Point) value), and the like. The elements (fields of retrieval targets) also include a source IP address (IP src), a destination IP address (IP dst), a TCP source port number, a TCP destination port number, a ToS (Type of Service) value, and the like.

For this reason, a flow table is created using, for example, a TCAM (Ternary Content Addressable Memory), and the entire region exclusive of a search target in elements is masked such that an arbitrary region of the element is the search target (the search with mask is performed on the region).

In contrast, in OpenFlow ver. 1.1 or later, division of a flow table into a plurality of tables is permitted, as illustrated in FIG. 2B. OpenFlow makes no reference to a method for implementing a flow table in the OF-SW 2. That is, there is no limit to the number of flow tables implemented in the OF-SW 2 and the data structure of each flow table. For example, a plurality of tables storing match criteria may be provided in the OF-SW 2, and one or more tables (action tables) including entries for pieces of action information corresponding to the tables may be provided. The configuration according to the embodiment can be applied to both OpenFlow ver. 1.0 and OpenFlow ver. 1.1.

A configuration for allowing curbing of a lowering in throughput due to a lowering in performance (e.g., a lowering in retrieval speed) caused by the search with mask will be described below. A requirement for a search table, such as a flow table, is that entries for match criteria are registered in the table such that all packets matching the match criteria (that are elements of a set stipulated by the match criteria) are searched for.

When an element as a match criterion is such that a mask position can be appropriately changed, like an IP address, a flow table is formed as a search table with mask. This allows storage of a plurality of entries (match criteria) different in mask position (e.g., having different prefix lengths) in a single table.

This is achieved by flexibility of a table with mask which allows adoption of a different mask position for each entry. A table need not have flexibility as long as a desired packet can be searched in the table. That is, when all packets that can be searched in a search table with mask at a given time can be searched in a search table without mask expressed by individual entries, the search table with mask and the search table without mask can be said to be equivalent in functionality.

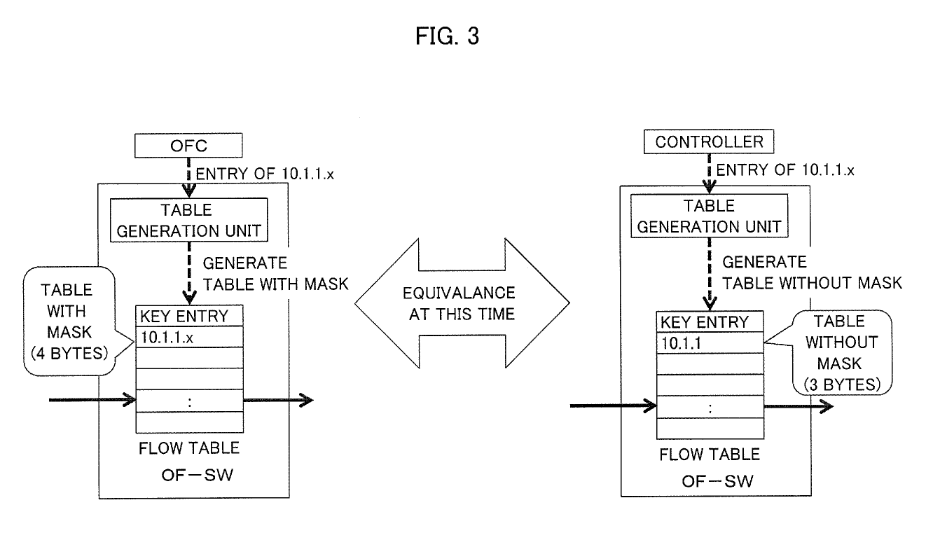

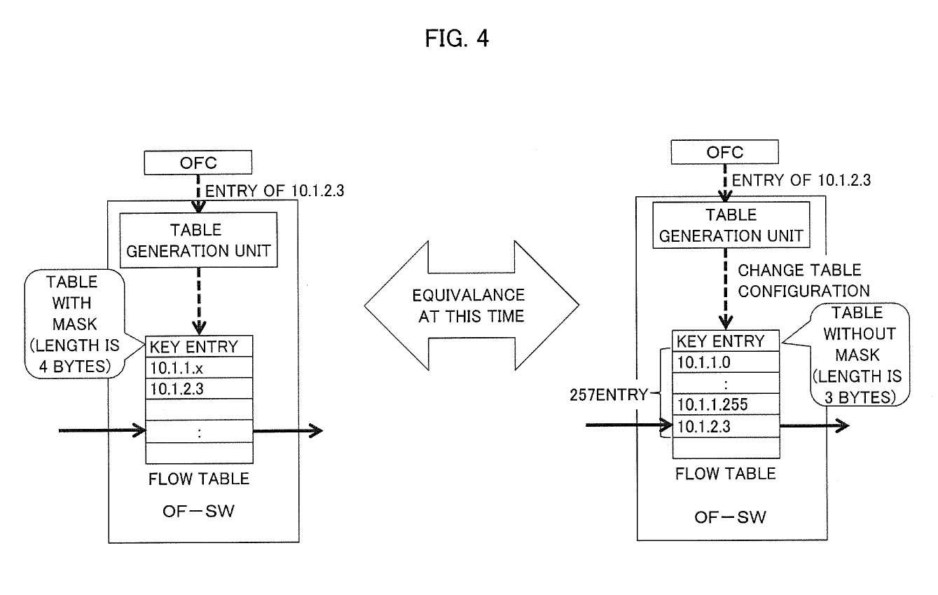

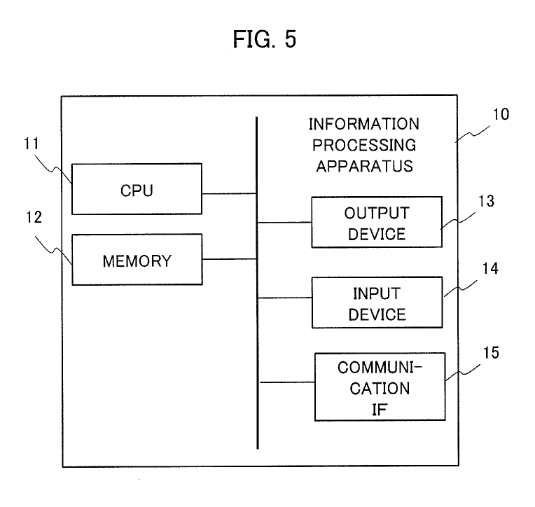

FIGS. 3 and 4 are explanatory diagrams according to the embodiment. Assume a case where search is performed using an IP address as a match criterion. In the description below, a piece of information which is registered in a table and is to be matched against a piece of information extracted as a search key from a packet may be called a “key entry” or a “piece of key information”. The piece of information extracted as the search key may be called a “piece of key information”.

An OF-SW receives a request from an OFC for addition of a flow entry including the match criteria “10.1.1.x/24” (three high-order bytes are a prefix and one low-order byte may be masked).

A table generation unit of the OF-SW generates, as a flow table, a table with mask (a length of key is 4 bytes: the table with mask (4 bytes)) including the flow entry for “10.1.1.x” in accordance with an instruction from the OFC (see the left side in FIG. 3).

With “10.1.1.x”, 256 types of packets having respective IP addresses of 10.1.1.0 to 10.1.1.255 among packets arriving at the OF-SW can be detected. Note that the prefix length of an IP address can be appropriately set. In this case, the flow table is formed to be capable of storing an entry different in mask length or mask position (e.g., when two low-order bytes are masked or the like).

At a time point when “10.1.1.x” alone is registered as a key entry in the table with mask (4 bytes), the table with mask is equivalent to a table without mask (a length of key is 3 bytes) having a registered entry “10.1.1”, as illustrated on the right side in FIG. 3. That is, the same IP address can be detected even in a table where one low-order byte is not included in a search target, as in the table with mask (4 bytes). Note that, when the tables differ in retrieval speed, a table higher in retrieval speed (shorter in search time) is considered as a high-performance table.

As illustrated in FIG. 4, assume a case where an IP address of “10.1.2.3” (a length of key is 4 bytes and there is no mask) is added to and registered in a flow table as a match criteria. As illustrated on the left side in FIG. 4, an entry “10.1.2.3 (no mask)” is added, and the added entry is used for a packet including an IP address “10.1.2.3”. With respect to the entry “10.1.1.x”, One (1) byte in low-order may be masked as a portion that is not referred in a search.

It is impossible to add the entry “10.1.2.3 (no mask)” to a table that a length of key is 3 bytes as illustrated on the right side in FIG. 3. This is because the byte length of a search target is different. A method is conceivable for, when an instruction for addition of an entry which is unable to be registered in an existing table arrives, changing a table type and constructing a table in which all of packets that can be searched with existing entries and all of packets that can be searched with the entry related to the instruction for addition can be searched.

In the example in FIG. 3, the entry “10.1.1 (no mask)” can be considered to be equivalent to 256 types of entries “10.1.1.0” to “10.1.1.255”. For this reason, as illustrated on the right side in FIG. 4, a table where the 256 entries corresponding to “10.1.1.0” to “10.1.1.255” and the entry “10.1.2.3” related to the instruction for addition are registered is constructed. That is, the table type (structure) is changed from a “table without mask (3 bytes)” to a “table with mask (4 bytes)”. Such a table allows detection of all elements (packets) covered by “10.1.1.x” and “10.1.2.3.”

The table on the left side in FIG. 4 and the table on the right side are equivalent in that all of desired packets can be detected. Note that when the table on the left side and the table on the right side differ in retrieval speed, a table type higher in retrieval speed is preferably selected. For example, in general, a table with mask is considered to be lower in performance than an unmasked table. However, when the number of entries is very small, the retrieval speed may be higher than in exact match search using a hash operation.

For this reason, when there are a plurality of table types which support entry addition, a table higher in performance (higher in retrieval speed (shorter in search time)) is selected on the basis of the numbers of entries for tables. This allows curbing of a lowering in retrieval speed involved with entry addition and avoidance of a lowering in throughput. The details of a switch (OF-SW) according to the embodiment will be described below.

<Configuration of Switch (OF-SW)>

FIG. 5 illustrates an example of the hardware configuration of an information processing apparatus (computer) 10 which can be used as each of the OFC 1 and the OF-SWs 2. As the information processing apparatus 10, for example, a general-purpose computer, such as a personal computer (PC) or a workstation (WS) can be used. Alternatively, a dedicated computer, such as a server machine, can also be used. Note that a computer other than the PC, the WS, and the server machine as described above may be used.

As illustrated in FIG. 5, the information processing apparatus 10 includes, for example, a central processing unit (CPU) 11, a memory 12, an output device 13, an input device 14, and a communication interface (communication IF) 15 which are connected to one another via a bus. The CPU 11 is an example of a “control unit” or a “control device”. The memory 12 is an example of a “storage device”, a “storage unit”, or a “storage medium”.

The memory 12 includes a main storage device and an auxiliary storage device. The main storage device is used as a region for deployment of a program, a work region for the CPU 11, a storage region for data and a program, or a buffer region. The main storage device is formed as, for example, a random access memory (RAM) or a combination of a RAM and a read only memory (ROM).

The auxiliary storage device is formed from a nonvolatile storage medium, such as a hard disk drive (HDD), a solid state drive (SSD), a flash memory, or an electrically erasable programmable read-only memory (EEPROM). The auxiliary storage device is used as a storage region for data and a program.

The output device 13 outputs data and a piece of information. The output device 13 is, for example, a display or a printer. The input device 14 is used to input a piece of information and data. The input device 14 is, for example, a key, a button, a pointing device, such as a mouse, or a touch panel.

The communication IF 15 is an interface circuit which is connected to a network and transmit and receive data to and from another communication apparatus. As the communication IF 15, for example, a local area network (LAN) card or a communication interface card called a network interface card (NIC) is used.

The CPU 11 is an example of a processor, and loads a program stored in at least one of the main storage device and the auxiliary storage device in the memory 12 onto the main storage device and executes the program. With this configuration, the CPU 11 makes the information processing apparatus 10 work as the OFC 1 or the OF-SW 2.

The CPU 11 is also called an MPU (microprocessor) or a processor. The CPU 11 is not limited to a single processor and may have a multiprocessor configuration. Alternatively, a single CPU which is connected via a single socket may have a multicore configuration. At least a part of processing to be performed by the CPU 11 may be performed by a processor other than a CPU, such as a dedicated processor like a digital signal processor (DSP), a graphics processing unit (GPU), a numerical data processor, a vector processor, or an image processor.

At least a part of the processing to be performed by the CPU 11 may be performed by an integrated circuit (IC) or any other digital circuit. The integrated circuit or the digital circuit may include an analog circuit. Examples of the integrated circuit include an LSI, an application specific integrated circuit (ASIC), and a programmable logic device (PLD). Examples of the PLD include a field-programmable gate array (FPGA). At least a part of the processing to be performed by the CPU 11 may be executed by a combination of a processor and an integrated circuit. Such a combination is called, for example, a microcontroller (MCU), a SoC (system-on-a-chip), a system LSI, a chip set, or the like.

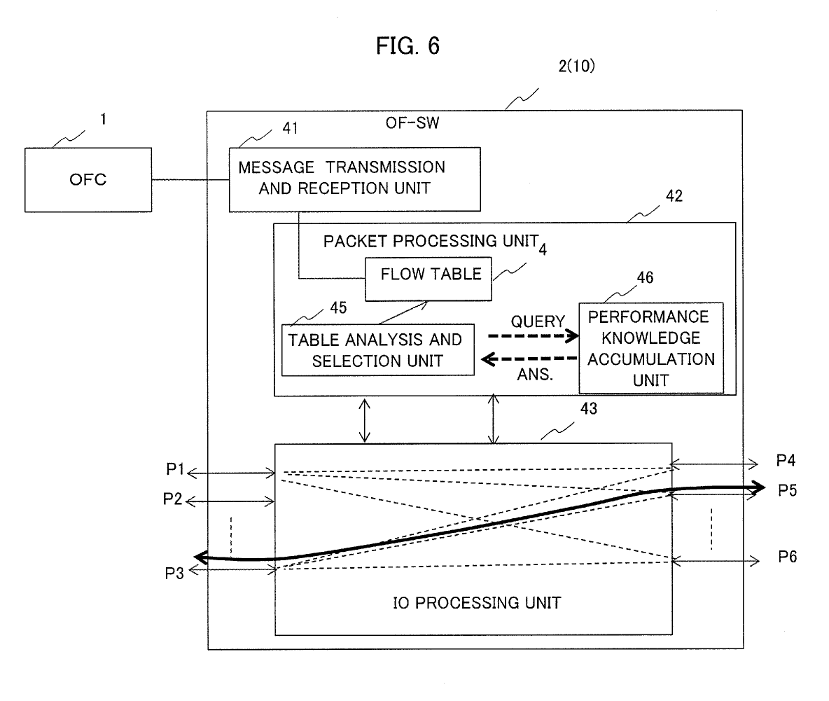

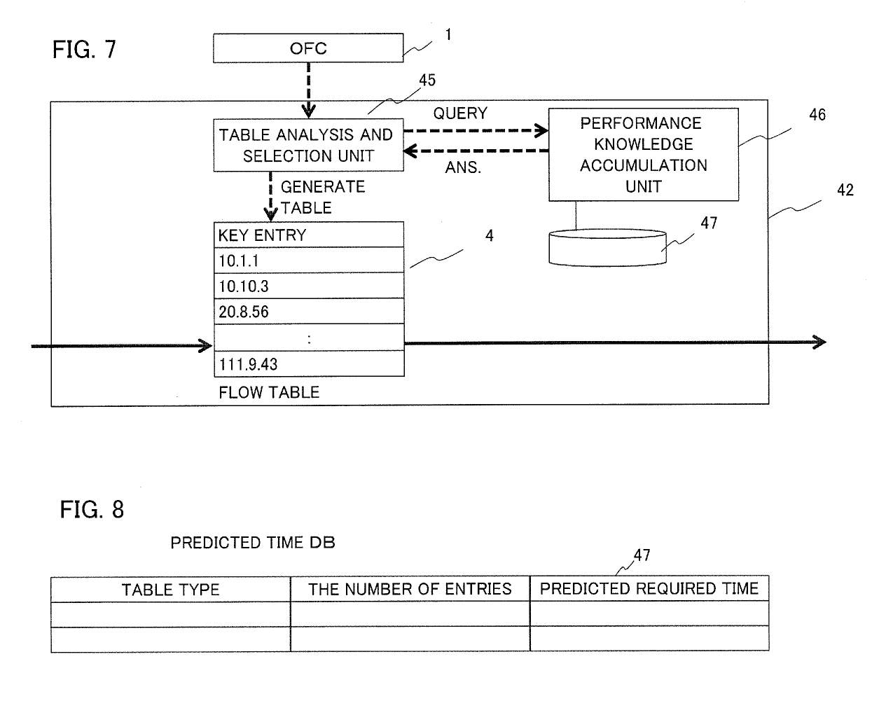

FIG. 6 is a diagram schematically illustrating functions of the switch (OF-SW) 2. FIG. 7 is a diagram schematically illustrating functions related to flow table creation of the switch (OF-SW) 2. The OF-SW 2 is an example of a “packet processing apparatus”.

In FIG. 6, the OF-SW 2 includes a message transmission and reception unit 41, a packet processing unit 42, and an input and output processing unit (IO processing unit) 43. The packet processing unit 42 includes the flow table 4, a table analysis and selection unit 45, and a performance knowledge accumulation unit 46. Note that the table analysis and selection unit 45 and the performance knowledge accumulation unit 46 may each be independent of the packet processing unit 42.

The message transmission and reception unit 41 communicates with the OFC 1 and exchanges messages. For example, the message transmission and reception unit 41 transmits a request for provision of a flow entry to the OFC 1 and receives a message of request for registration (request for addition) of a flow entry from the OFC 1.

The input and output processing unit 43 has a plurality of ports. Ports P1 to PG are illustrated as an example of the plurality of ports in FIG. 6. Each of the ports P1 to P6 can be used as at least one of an input port and an output port for a packet.

The packet processing unit 42 performs a process of searching in the flow table 4 in relation to a packet received through a port of the input and output processing unit 43 and finds out an entry including match criteria which match the packet. The packet processing unit 42 finds out a piece of action information corresponding to the match criteria and performs an operation based on the piece of action information. For example, when the piece of action information indicates outputting a packet through a predetermined port (e.g., the port P5), the input-output processing unit 43 outputs the packet through the port P5.

Note that the communication IF 15 illustrated in FIG. 5 operates as the message transmission and reception unit 41 and the input-output processing unit 43. The CPU 11 operates as the packet processing unit 42, the table analysis and selection unit 45, and the performance knowledge accumulation unit 46. The flow table 4 and pieces of information and data (a predicted time DB 47, various determination thresholds, and the like) to be managed by the table analysis and selection unit 45 and the performance knowledge accumulation unit 46 are stored in the memory 12.

The table analysis and selection unit 45 extracts a plurality of table types as potential candidates among from a plurality of table types on the basis of a piece of key entry information registered (stored) in the current flow table 4 and a piece of flow entry information (including a piece of key entry information), addition of which is requested by the OFC 1.

The table analysis and selection unit 45 supplies, for each candidate, pieces of information (pieces of table configuration information), such as a table type and the number of entries in a constructed table, to the performance knowledge accumulation unit 46 and inquires a predicted required time based on the pieces of information of the performance knowledge accumulation unit 46. Note that candidates may be a plurality of multistage tables different in type. In this case, the type and the number of entries of each of tables forming each multistage table, and the number of stages of the table constitute a piece of table configuration information. A predicted required time indicates a predicted value of a time required for search in a case where the search is performed using a table found out from a table type, the number of entries, and the like. The predicted required time is also a piece of information indicating a retrieval speed.

The performance knowledge accumulation unit 46 manages the predicted time database (predicted time DB) 47 that stores a predicted required time for packet processing for each of combinations of table types and values of the number of entries. FIG. 8 illustrates an example of the data structure of the predicted time DB 47. The predicted time DB 47 is formed from one or more entries (records), each of which is associated with a table type, a value of the number of entries, and a predicted required time. Note that, when a candidate is a multistage table, a predicted required time for each of tables forming the multistage table is read out from the predicted time DB 47, and the total value of the predicted required times can be used as a predicted value of a search time.

A piece of information stored in the predicted time DB 47 may be manually stored in advance. A time obtained by measuring an actual packet processing time may be stored in the predicted time DB 47. A value manually stored in the predicted time DB 47 may be updated through actual time measurement.

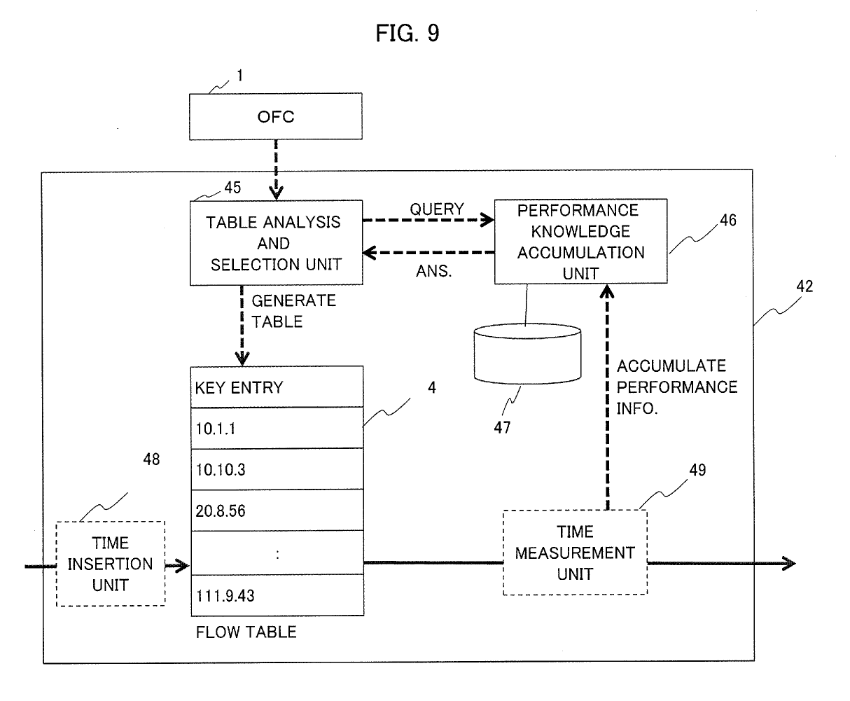

When a predicted required time is obtained through measurement of an actual packet processing time, for example, a configuration according to another embodiment of the OF-SW 2 illustrated in FIG. 9 can be adopted. As illustrated in FIG. 9, the OF-SW 2 includes a time insertion unit 48 and a time measurement unit 49. The time insertion unit 48 attaches a piece of current time information to a packet. The time measurement unit 49 calculates a required time by subtracting a current time attached to the packet from a time after search using the flow table 4. Notification of the required time is given to the performance knowledge accumulation unit 46, and the performance knowledge accumulation unit 46 stores the required time in the predicted time DB 47. At this time, the performance knowledge accumulation unit 46 has the pieces of information of the table type and the number of entries of the flow table 4 being used for search, which are obtained from the table analysis and selection unit 45, and associates the pieces of information with the required time and stores the pieces of information in the predicted time DB 47.

With the above-described configuration, even if a piece of predicted required time information is not stored in advance in the predicted time DB 47, the predicted time DB 47 can be constructed. Even in the presence of advance storage, accuracy can be enhanced by actual measurement of a required time.

Note that it may be difficult to select a table shorter in packet processing time (e.g., table search time) from among candidates due to insufficiency of pieces of information accumulated in the predicted time DB 47. In this case, the performance knowledge accumulation unit 46 collects data on required times using the time insertion unit 48 and the time measurement unit 49 while selecting one from among candidates given by the table analysis and selection unit 45 and giving a reply. In the above-described manner, data can be accumulated in the predicted time DB 47. For example, it is possible to collect data on required times for a plurality of table types and a plurality of values of the number of entries by, for example, changing a table type, for which a reply to an inquiry is to be given, with desired frequency, every predetermined number of times, or the like and to accumulate data in the predicted time DB 47.

The flow table 4 is an example of “a table that includes a piece of packet identification information and a piece of information indicating a process corresponding to the piece of packet identification information”. Match criteria to be stored in the flow table 4 are an example of “a piece of packet identification information”, and an action to be stored in the flow table 4 is an example of “a piece of information indicating a process corresponding to the piece of packet identification information”. The flow table 4 can be formed as a one-stage or multiple-stage table. The packet processing unit 42 is an example of “a processing unit”. The table analysis and selection unit 45 is an example of “an acquisition unit” and an example of “a management unit”. The performance knowledge accumulation unit 46 is an example of “a selection unit” and an example of “an accumulation unit”. The predicted time DB 47 is an example of “a storage unit”.

<Process by Table Analysis and Selection Unit>

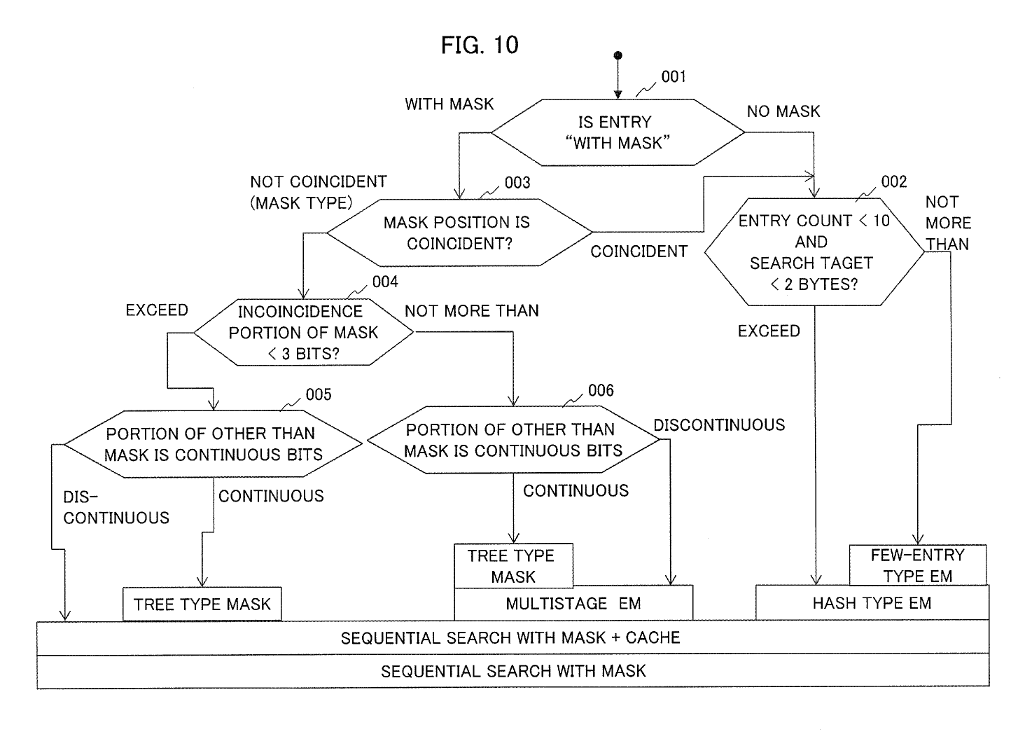

FIG. 10 is a flowchart illustrating an example of a process of determining a table type (candidate) to be performed by the table analysis and selection unit 45. The process illustrated in FIG. 10 is performed by the CPU 11 that operates as the table analysis and selection unit 45. The process illustrated in FIG. 10 is started when the CPU 11 obtains a key entry (match criteria) in the existing flow table 4 and a key entry (match criteria) of a flow entry, addition of which is requested by the OFC 1.

In a process denoted by 001 in FIG. 1, the CPU 11 determines whether an existing key entry (an existing entry) or a new key entry (a new entry) has a mask (“with mask”). When the existing entry or the new entry does not have a mask (“no mask”), the process advances to 002. Otherwise, the process advances to 003.

When the process advances to 002, the CPU 11 determines whether a count obtained by adding the number of flow entries to one (1) is not more than a predetermined count (e.g., 10) and the number of bytes of a search target is not more than a predetermined byte count (e.g., 2 bytes).

When it is determined that the number of entries is not more than the predetermined count and that the number of bytes of the search target is not more than the predetermined byte count, the CPU 11 determines that “few-entry type EM”, “hash type EM”, “sequential search with mask plus cache system”, and “sequential search with mask” are table type candidates.

On the other hand, when it is determined that at least one of the number of entries and the number of bytes of the search target exceeds the corresponding predetermined count, the CPU 11 determines that “hash type EM”, “sequential search with mask plus cache system”, and “sequential search with mask” are table type candidates.

When the process advances to 003, the CPU 11 determines whether a mask position of the existing entry is coincident with a mask position of the new entry. When it is determined that the mask position of the existing entry is coincident with the mask position of the new entry, the CPU 11 advances the process to 002. On the other hand, when it is determined that the mask position of the existing entry is not coincident with the mask position of the new entry, the CPU 11 advances the process to 004.

Note that, in a case as well where one of the existing entry and the new entry is “with mask” and the other is “no mask” in the process denoted by 001, the process denoted by 003 is performed. In this case, it is determined whether a mask position is coincident with a portion which is not a search target of the unmasked key entry. For example, as in the example illustrated in FIG. 3, it is determined whether a portion (one low-order byte) which does not become a search target in a search using the table without mask (3 bytes) and a portion (one low-order byte) which is masked in the search using the search table with mask are coincident.

In the process denoted by 004, the CPU 11 determines whether the number of bits of a portion of incoincidence between the mask position of the existing entry and the mask position of the new entry is not more than a predetermined number (e.g., 3 bits). When it is determined that the number of bits of the portion of incoincidence is not more than the predetermined number, the CPU 11 advances the process to 006. On the other hand, when the number of bits of the portion of incoincidence exceeds the predetermined number, the CPU 11 advances the process to 005.

In the process denoted by 005, the CPU 11 determines whether bits of an unmasked portion (the whole except a mask) of each of the existing entry and the new entry are continuous or discontinuous (discretely present). When it is determined that the bits are continuous, the CPU 11 determines that “tree type mask”, “sequential search with mask plus cache system”, and “sequential search with mask” are table type candidates.

On the other hand, when it is determined that the bits are discontinuous, the CPU 11 determines that “sequential search with mask plus cache system” and “sequential search with mask” are table type candidates.

In the process denoted by 006, the CPU 11 determines whether bits of portion of other than a masked portion (the whole except a mask) of each of the existing entry and the new entry are continuous or discontinuous (discretely present). When it is determined that the bits are continuous, the CPU 11 determines that “tree type mask”, “multistage EM”, “sequential search with mask plus cache system”, and “sequential search with mask” are table type candidates.

On the other hand, when it is determined that the bits are discontinuous, the CPU 11 determines that “multistage EM”, “sequential search with mask plus cache system” and “sequential search with mask” are table type candidates.

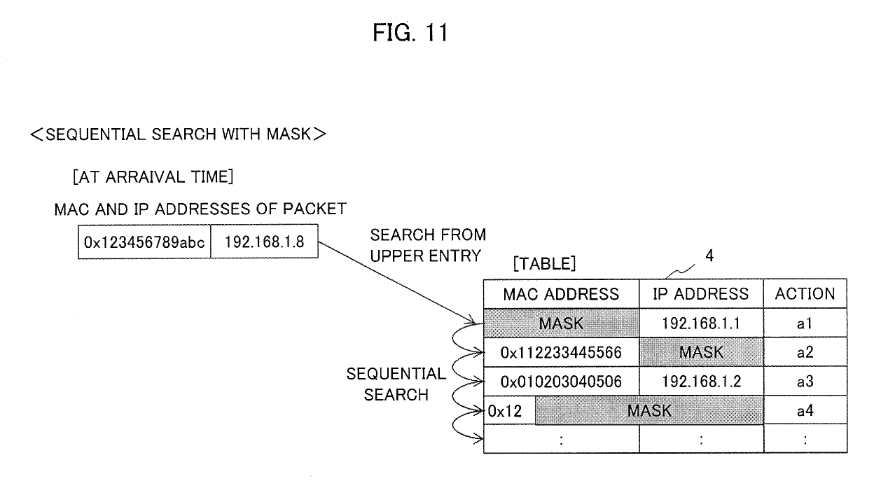

Each of the table types illustrated in FIG. 10 will be described. FIG. 11 is an explanatory diagram of the table type “sequential search with mask”. A table of “sequential search with mask” has a table configuration in which a part of a bit string forming a key entry is set as a search target and a portion which need not be referred to can be masked. In “sequential search with mask”, entries are referred to in order from a leading (top) entry at the time of entry search.

In the example illustrated in FIG. 11, at least one of a MAC address and an IP address (of at least one of a destination and a source) is set as a match criterion in the flow table 4, and a mask can be put on at least one of a MAC address and an IP address. A mask can be put on a part of each of a MAC address and an IP address.

As for a table of “sequential search with mask”, a plurality of types of match criteria can be adopted in one table. The adoption, however, complicates the structure of the table. For this reason, entries in a table are sequentially referred to, and matching processing based on the status of a mask put on each entry is performed. A retrieval speed is thus lower than in “tree type mask” or “hash type EM”.

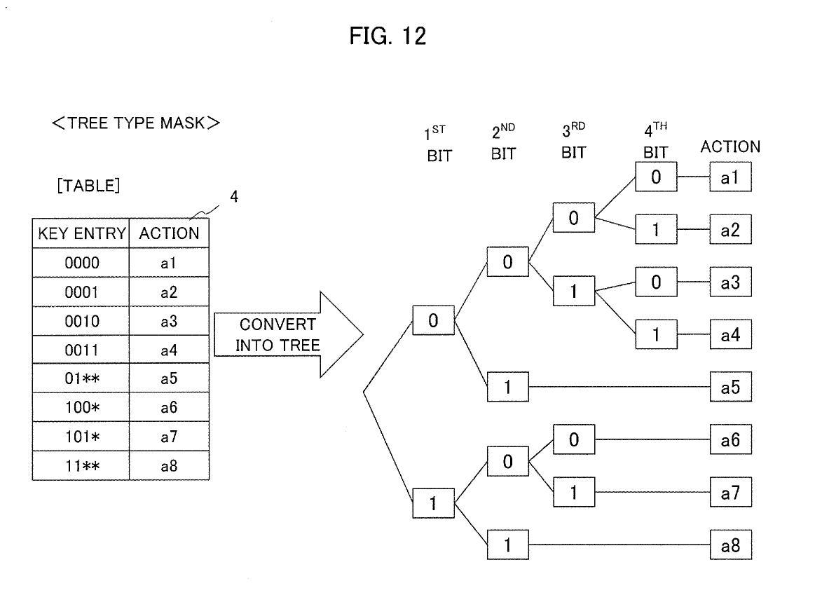

FIG. 12 is an explanatory diagram of a table of “tree type mask”. In the table of “tree type mask”, a key entry is decomposed into bits, and a matching entry is searched for during branching from a high-order bit. In a table of “tree type mask”, an arbitrary number of low-order bits can be masked (a mask is indicated by an asterisk (*) in FIG. 12, like “01**”). Note that a high-order bit or a middle bit is unable to be masked. It is impossible to make mask settings like “**01,” “0**1,” and the like.

When a part of a key entry is masked, search through the key entry ends at a lowest-order bit of an unmasked portion. In the example illustrated in FIG. 12, a key entry is formed of 4 bits, and search ends with up to four visits in a tree. “Tree type mask” is used for, for example, search for an IP address, low-order bits of which are masked in accordance with a prefix.

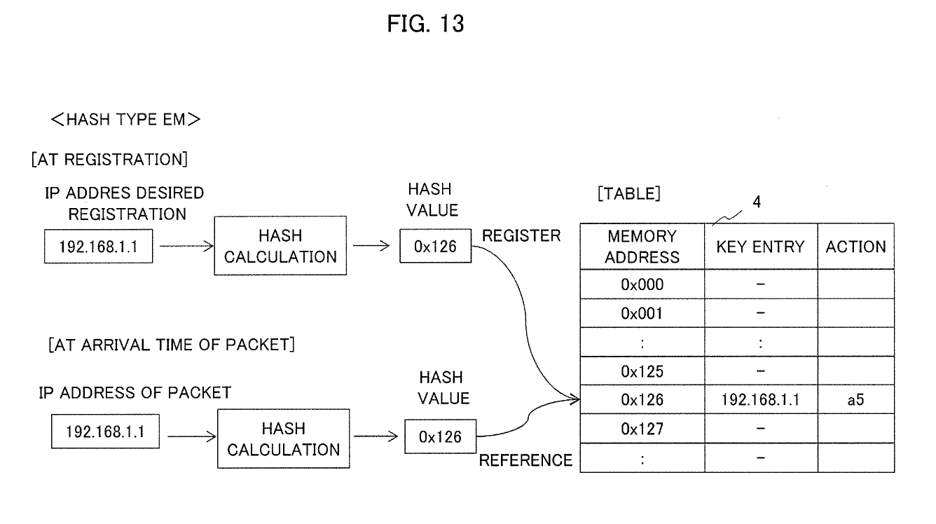

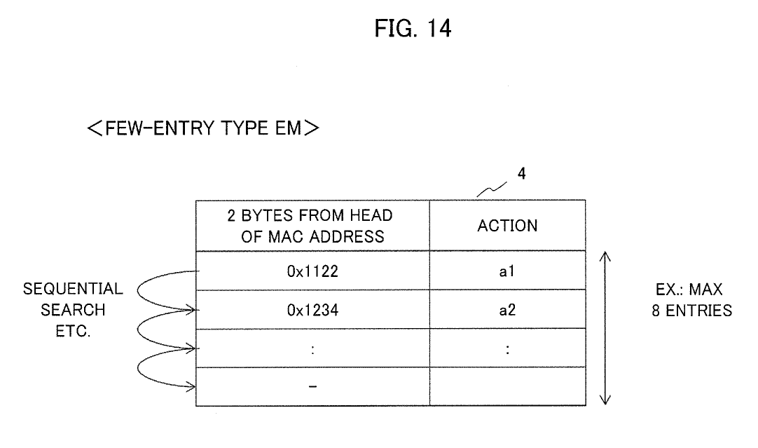

FIG. 13 is an explanatory diagram of the table type “hash type EM”. Hash type EM is one of exact match (EM) search systems. In hash type EM, a hash operation is performed on a bit string of a key entry, and an obtained hash value is set as an information storage destination memory address.

For example, assume that a 32-bit IP address is a key entry (match criterion). In this case, a hash operation is performed on an IP address (e.g., 192.168.1.1) as a registration target at the time of registration of a flow entry. The hash operation causes the IP address to degenerate into, for example, a 12-bit hash value (0x126). A key entry (a piece of key information) of “192.168.1.1” and a piece of action information are associated and are registered (stored) at a memory address of “0x126”.

When a packet having an IP address of “192.168.1.1” arrives at the OF-SW 2, a hash value of “0x126” is calculated by a hash operation on the IP address. The piece of action information corresponding to the key entry stored at the memory address matching the hash value is searched for. As described above, serial search in a table is not required, and a search time is shorter than in sequential search. That is, high-speed search is possible.

FIG. 14 is an explanatory diagram of the table type “few-entry type EM”. “Few-entry type EM” is one of exact match (EM) search systems. In “few-entry type EM”, the number of entries to be registered in a table is limited to a predetermined number (8 at most in the example in FIG. 14), and search processing is simplified. As a search method, sequential search that performs search in order from a leading entry is used. Alternatively, a method that sets a piece of key information at a memory address without change or the like is also conceivable as a search method.

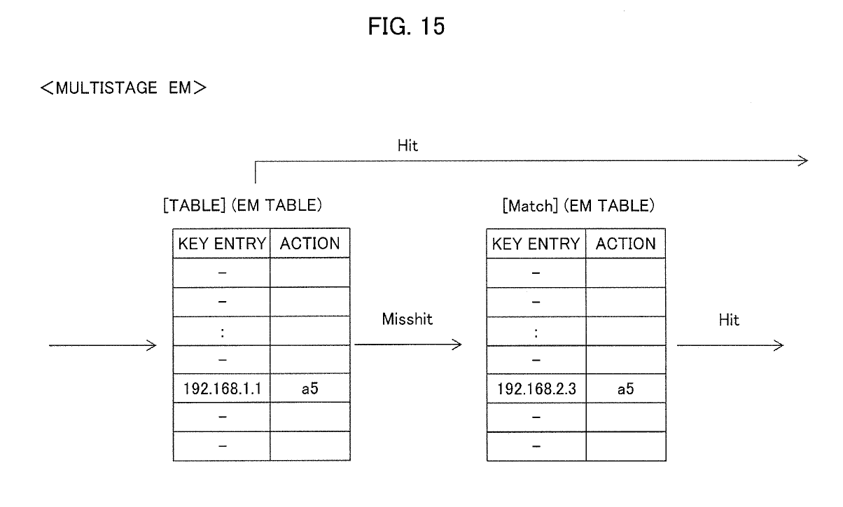

FIG. 15 is an explanatory diagram of the table type “multistage EM”. “Multistage EM” has a table configuration in which tables of “hash type EM” or “few-entry type EM” described above (EM tables) are arranged in series. The number of stages is set to a number not less than 2. For example, in the case of a two-stage table configuration, search using a first table is performed. When a matching entry is found, search in a table in a next or subsequent stage is skipped. When no matching entry is found, search in the table in the next stage is executed.

As a search method, search using a hash value or sequential search is used. For example, when a plurality of flow entries are put into one table, “sequential search with mask” is used. Use in a case where a plurality of flow entries can be expressed as a plurality of EM tables is conceivable.

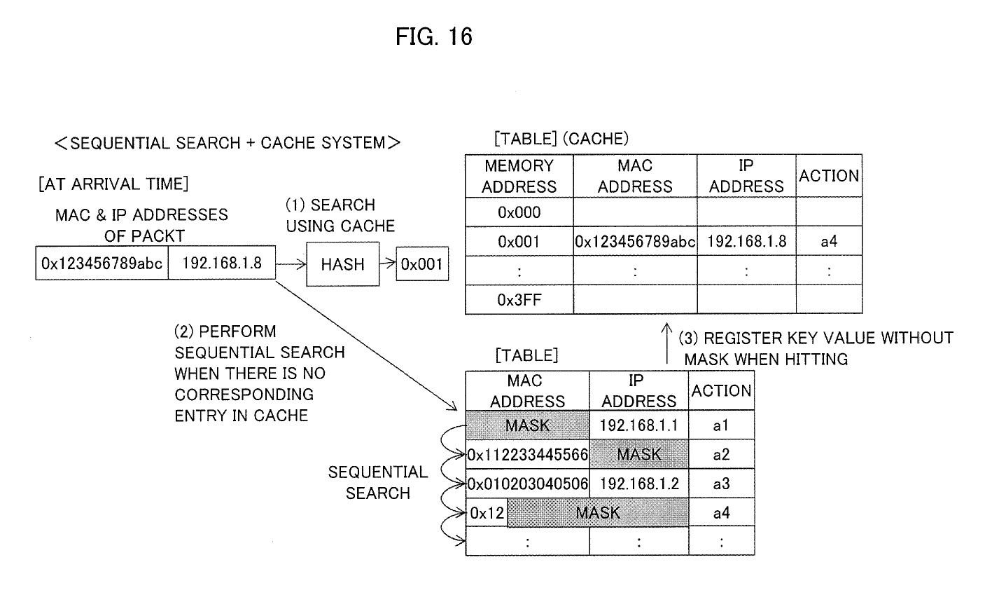

FIG. 16 is an explanatory diagram of the table type “sequential search with mask plus cache system”. “Sequential search with mask plus cache system” has a table configuration which has a hash type EM table as a cache to compensate for shortcomings of “sequential search with mask”.

As illustrated in FIG. 16, in “sequential search with mask plus cache system”, a hash type EM table and a sequential search with mask table are prepared. When a packet arrives, a piece of key information (a MAC address and an IP address in the example in FIG. 16) is extracted from the packet. A hash value is calculated from the MAC address and the IP address, and a cache (the EM table) is searched using the hash value. When a corresponding entry is found, the search ends. On the other hand, when no entry is found in the cache (EM table), sequential search using the sequential search with mask table is executed.

When a corresponding entry is found by the search using the sequential search with mask table, the operation below is performed. More specifically, an entry including the piece of key information (with no mask), an “action” in the found entry, and the hash value of the piece of key information is registered in the cache (EM table). Thereby, search using the same piece of key information can be performed at higher speed using the cache (EM table) than sequential search.

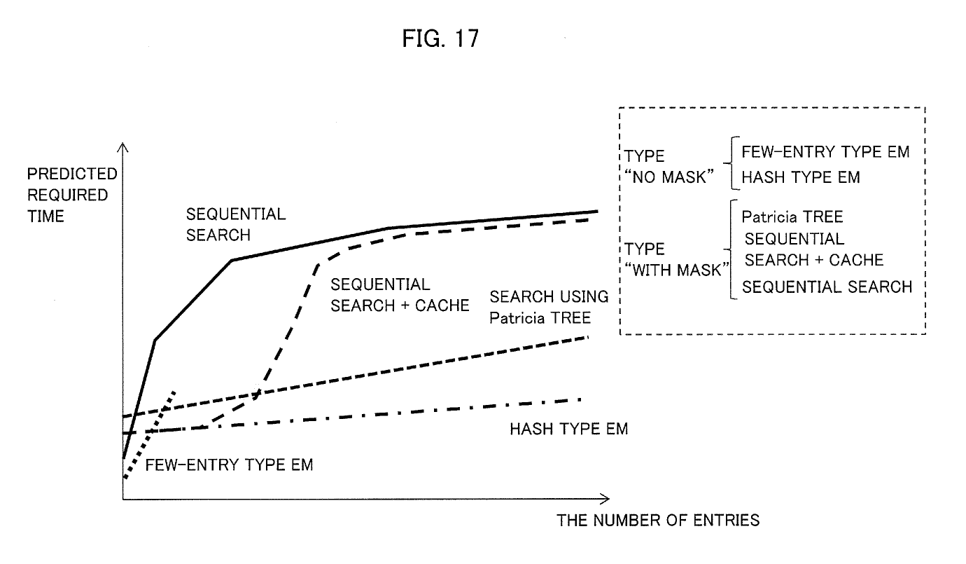

FIG. 17 is a graph illustrating the relationship between the number of entries and a predicted required time for each of a plurality of table types. Data illustrated in the graph is stored in the predicted time DB 47 so as to have, for example, the data structure illustrated in FIG. 8. Reading from and writing to the predicted time DB 47 are performed by, for example, the performance knowledge accumulation unit 46.

Table types are roughly divided into two types. One is a type of “no mask” (unmasked type) and the other is a type of “with mask” (masked type). Unmasked type ones include “few-entry type EM” and “hash type EM”. Note that “multistage EM” is included in unmasked type ones. Masked type ones include “tree type mask (Patricia tree type mask)”, “sequential search plus cache system”, and “sequential search”.

The table analysis and selection unit 45 inquires a table type shorter in predicted required time of the performance knowledge accumulation unit 46 when a plurality of candidates are obtained.

<Process by Performance Knowledge Accumulation Unit>

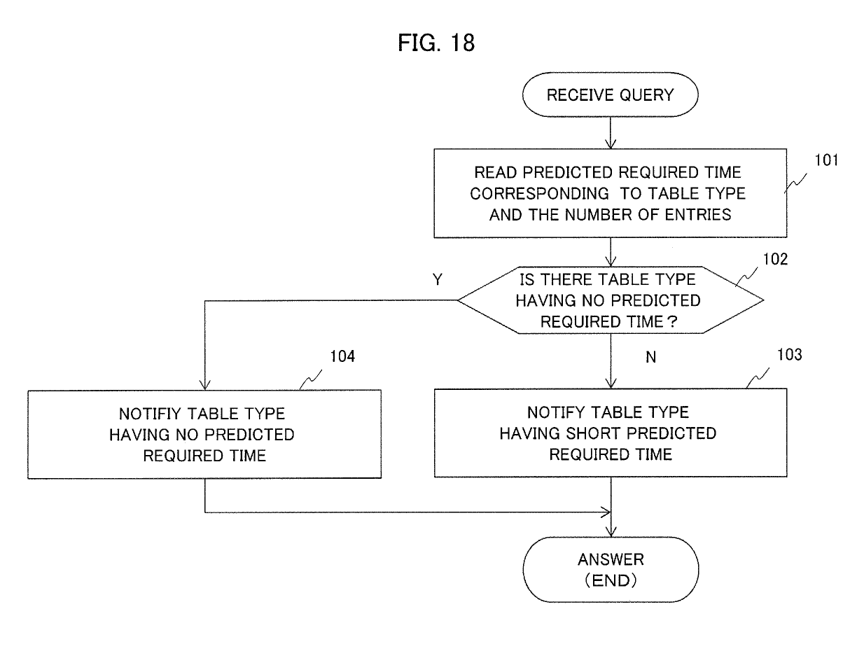

FIG. 18 is a flowchart illustrating an example of a process by the performance knowledge accumulation unit 46. The process in FIG. 18 is performed by, for example, the CPU 11 that operates as the performance knowledge accumulation unit 46. The process in FIG. 18 is started when a plurality of candidate table types and the number of entries are received from the table analysis and selection unit 45.

In a process denoted by 101, the CPU 11 refers to the predicted time DB 47 and reads out a predicted required time (predicted processing time) corresponding to each table type. Note that, when the table type is multistage EM, a total value of predicted required times of tables forming a multistage table is set as a predicted required time for multistage EM on the basis of the type and the number of entries of each of the tables (notification of which is given from the table analysis and selection unit 45).

In a process denoted by 102, the CPU 11 determines whether there is any table type (an example of a first candidate), a corresponding predicted required time of which is not stored in the predicted time DB 47. When there is no table type, a corresponding predicted required time of which is not stored in the predicted time DB 47, the process advances to 103. When there is any table type, a corresponding predicted required time of which is not stored in the predicted time DB 47, the process advances to 104.

In a process denoted by 103, the CPU 11 compares predicted required times of the plurality of candidates, finds out a table type shorter in predicted required time among the plurality of candidates, and notifies the table analysis and selection unit 45 of the table type. As described above, a table type shorter in predicted required time, i.e., shorter in search time (higher in performance) is selected.

As described above, when there are a plurality of candidate table types, the table analysis and selection unit 45 inquires a table type higher in performance (shorter in search time) of the performance knowledge accumulation unit 46. The performance knowledge accumulation unit 46 gives a table type higher in performance as a reply to the table analysis and selection unit 45 on the basis of the table types and the number of entries. The table analysis and selection unit 45 determines the type of a table to be created in response to the reply from the performance knowledge accumulation unit 46.

In a process denoted by 104, the CPU 11 sends a table type (an example of a “first candidate”), a predicted required time of which is not accumulated, as a reply to the inquiry to the table analysis and selection unit 45. When there are a plurality of table types, a predicted required time of which is not accumulated, one selected in accordance with a predetermined rule among from the plurality of table types is sent as a reply to the inquiry to the table analysis and selection unit 45.

Such a selection may be such that the same table type is given as a reply a predetermined number of times in a row or such that a different table type is given as each reply. In this case, the CPU 11 measures a time required for search using the time insertion unit 48 and the time measurement unit 49 and stores a predicted required time based on a measured value in the predicted time DB 47. Data may be accumulated in the predicted time DB 47 in the above-described manner. That is, when a processing unit performs search using a table corresponding to a first candidate, the type of the table corresponding to the first candidate, the number of pieces of packet identification information stored in the table corresponding to the first candidate, and a time required for the search are stored in a storage unit.

<Table Change Process>

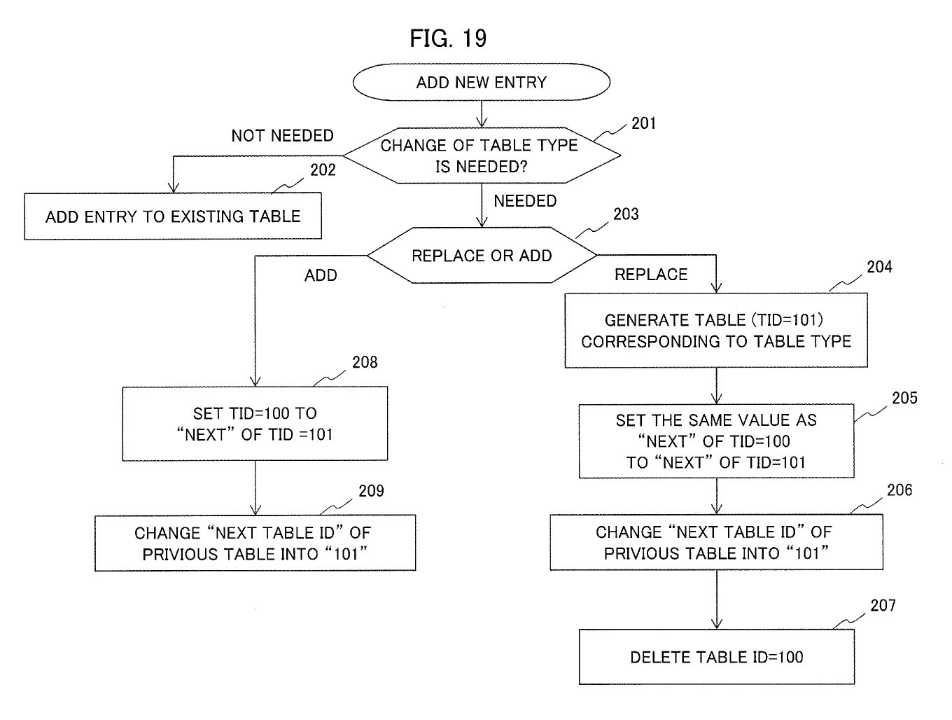

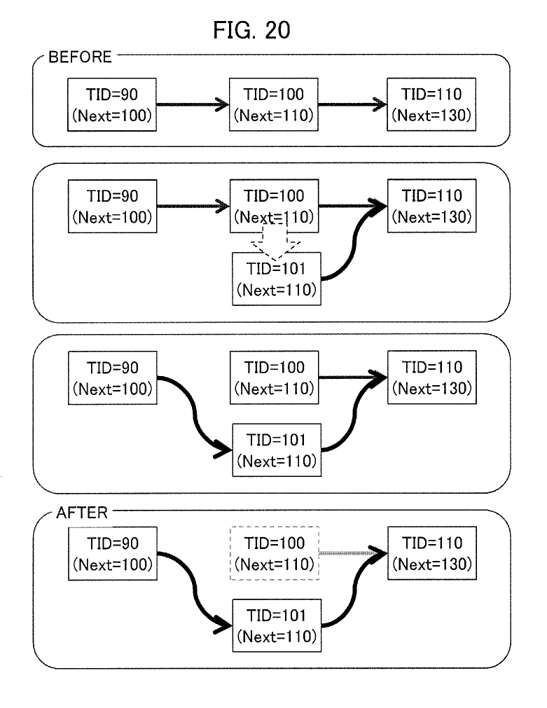

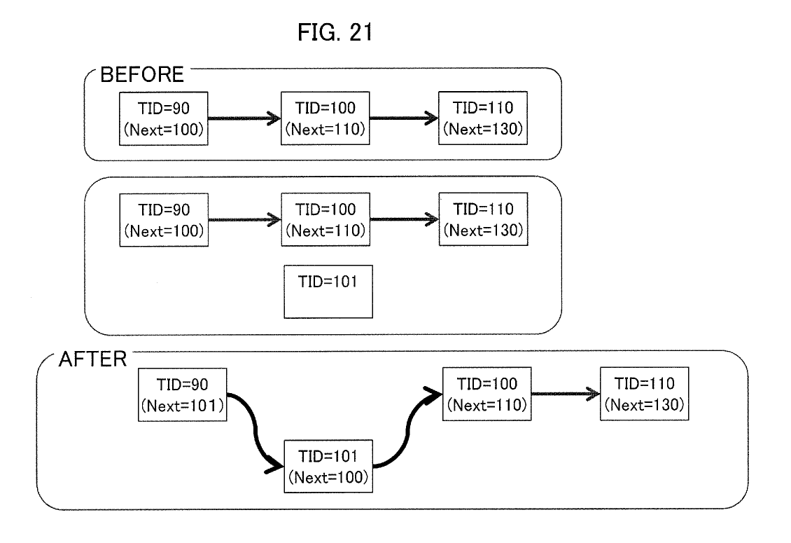

FIG. 19 is a flowchart illustrating an example of a table change process. FIG. 20 is an explanatory diagram of table change. FIG. 21 is an explanatory diagram of table addition. The process illustrated in FIG. 19 is performed by the CPU 11 that operates as the table analysis and selection unit 45.

In a process denoted by 201, the CPU 11 determines whether addition of a flow entry needs table type change. Whether table type change is required is determined on the basis of a result of the process in FIG. 10 or FIG. 18 described above.

When it is determined that table type change is unrequired, the CPU 11 adds an entry as an addition target to an existing flow table (202). When it is determined that table type change is required, it is determined whether the table type change is table replacement or table addition (203).

Table replacement means replacing the existing flow table with a flow table different in table type. Addition means adding a new table to have a multistage structure with the new table and the existing flow table.

In the case of replacement, processes denoted by 204 to 207 are executed. Replacement will be described with reference to FIG. 20. Byway of example, assume that a current (before change: before reception of a request for addition) table configuration has a table with a table ID (TID) of 90, a table with a TID of 100, and a table with a TID of 110. The table with the TID of 90 specifies that a next jump destination is the table with the TID of 100. The table with the TID of 100 specifies that a next jump destination is the table with the TID of 110. Note that the table with the TID of 110 specifies that a next jump destination is a table with a TID of 130 (not illustrated).

Assume that a request for addition of an entry to the table with the TID of 100 is made by the OFC 1 and that replacement of the table with the TID of 100 is determined as a result of processing by the table analysis and selection unit 45 and the performance knowledge accumulation unit 46.

By way of example, assume a case where a search table with mask with a key entry of “10.1.1.x” as illustrated on the left side in FIG. 3 is an existing table, and addition of a 4-byte key entry like “10.1.2.3” is requested. In this case, assume that “hash type EM” is selected from among a plurality of candidates and that change to “hash type EM” is determined. Note that “hash type EM” in the example is a table which has 257 types of entries illustrated on the right side in FIG. 4 and in which search across entries is performed by search using a hash value of a piece of key information as a memory address. The search table with mask in the example is an example of a first table, and a table of hash type EM is an example of a second table. The table analysis and selection unit 45 (the CPU 11) generates a “hash type EM” table as a second table as an example of a “management unit”.

In 204, the CPU 11 refers to an entry (see the table on the left side in FIG. 3) of the table with the TID of 100 and generates a table of hash type EM (with, for example, a TID of 101) which has 257 types of entries as illustrated on the right side in FIG. 4.

In 205, the CPU 11 sets a piece of next information (Next) of the table with the TID of 101 to the same value as that of the table with the TID of 100 (Next=110). In 206, a piece of next information of the previous table (with the TID of 90) to the TID of 101. The table with the TID of 100 is then deleted.

Although an example where a flow table has a multistage table configuration has been described in each of the examples in FIGS. 20 and 21, a flow table may have a single-stage configuration. This corresponds to a case where the table with the TID of 90 and the table with the TID of 110 are absent in FIG. 20 and the table with the TID of 100 is to be replaced (exchanged) with the table with the TID of 101.

In the case of addition, processes denoted by 208 and 209 are executed. Addition will be described with reference to FIG. 21. A current (before change) table configuration illustrated in FIG. 21 is the same as that in FIG. 20, and a description thereof will be omitted. As an example of addition, for example, assume a case where the table illustrated on the right side in FIG. 3 is an existing table (with a TID of 100: an example of a first table) and addition of a 4-byte key entry like “10.1.2.3” is requested. By way of example, it is assumed to be determined that “multistage EM” is selected, an EM table (with a TID of 101) for “10.1.2.3” is created, and that the created EM table and the EM table for “10.1.1” have a multistage configuration. The EM tables forming “multistage EM” are examples of a “second table”.

In this case, the CPU 11 creates the table with the TID of 101, sets a piece of next information (Next) of the table with the TID of 101 to the TID of 100 (208), and sets a piece of next information of a previous table (with a TID of 90) to the TID of 101 (209). With this operation, a table configuration is such that the table with the TID of 101 is inserted, as illustrated in FIG. 21. In the example, the EM table as the second table is arranged at a stage previous to the existing table as the first table. The EM table, however, may be arranged at a subsequent stage.

### Operation Example

An operation example and a process according to the embodiment will be described below. In the embodiment, a case will be described as an example where the flow table 4 is used as a forwarding table which forwards a packet to a next hop on the basis of an IP address.

A request for addition of a flow entry including an IP address with a prefix (having a specified prefix length) as a match criterion is transmitted from the OFC 1 to the OF-SW 2. Assume that no entry is present in the flow table 4 in an initial state and that the OF-SW 2 first registers a flow entry having an IP address with a prefix of “10.1.1.x/24” as a match criterion in the flow table 4 in response to a request from the OFC 1.

The request from the OFC 1 is received by the table analysis and selection unit 45, and the table analysis and selection unit 45 performs table analysis and determines a candidate table type. The table analysis and selection unit 45 extracts a candidate on the basis of the candidate extraction logic illustrated in FIG. 10. For example, when no entry is present in any table, and addition of an entry for “10.1.1.x/24” is requested, a determination of “masked” is made in 001, and a determination of “coincidance between mask positions” is made in 003 (because no existing entry is present). After that, since a region as a search target is 4 bytes long (an IPv4 address) in 002, “hash type EM”, “sequential search with mask plus cache system”, and “sequential search with mask” are extracted as table type candidates.

Pieces of information, such as the candidate table types and the current number of entries (1 in this case), are passed to the performance knowledge accumulation unit 46. The performance knowledge accumulation unit 46 manages the predicted time DB 47 having the data content illustrated in FIG. 17 and derives a table type shorter in predicted required time (e.g., shortest among candidates) on the basis of the table types and the number of entries. Note that a table type which ranks second or lower may be selected.

Since the number of entries is 1 in the example, “sequential search with mask” is derived from among the plurality of candidates, and the table analysis and selection unit 45 is notified of sequential search with mask. The table analysis and selection unit 45 generates the flow table 4 for the table type “sequential search with mask” and registers an entry with a match criterion of “10.1.1.x”.

Assume a case where an entry with a piece of key information, one low-order byte of which is masked, as a match criterion is then registered in the flow table 4. As can be seen from a graph for “sequential search” in FIG. 17, a predicted required time for “sequential search plus cache system” and a predicted required time for “hash type EM” are shorter than a predicted required time for “sequential search”. The predicted required time for “hash type EM” exceeds the predicted required time for “sequential search plus cache system”. In this case, the table analysis and selection unit 45 performs the table change process as illustrated in FIG. 19. Details of the process have already been described, and a second description thereof will be omitted. When a request for addition of an entry for “10.1.2.3” is received from the OFC 1 after that, table change (exchange) or addition (arrangement of a new table at a stage previous or subsequent to an existing table) is performed by the above-described processing.

### Effects of Embodiment

According to the embodiment, a plurality of table candidates different in type are acquired on the basis of a piece of key information (a piece of packet identification information) of an existing entry and a piece of key information (a piece of packet identification information) of an entry, addition of which is requested. A table shorter in predicted required time (search time) corresponding to the number of entries is selected from among the plurality of candidates, and the selected table is generated and used for search. This allows curbing of a lowering in retrieval speed and suppressing or avoidance of a lowering in throughput in the OF-SW 2. Components of the embodiment described above can be appropriately combined.

According to the above-described embodiments, it is possible to provide an apparatus and a method for suppressing a lowering of retrieval speed of a table.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A packet processing apparatus, comprising:
a memory configured to store a table including a piece of packet identification information and a piece of information indicating a process corresponding to the piece of packet identification information;
a processing unit configured to search for a process corresponding to a piece of packet identification information of a received packet from the table;
an acquisition unit configured to acquire a plurality of table candidates that have different types and in which all packets identified by a new piece of identification information for a packet and an existing piece of identification information for a packet are retrievable from the plurality of table candidates, based on the existing piece of packet identification information and the new piece of packet identification information when a request for addition of anew entry including the new piece of identification information for a packet is received; and
a selection unit configured to select a table used for a search by the processing unit from among the plurality of table candidates based on a number of pieces of packet identification information stored in each of the plurality of table candidates.

2. The packet processing apparatus according to claim 1, wherein the selection unit is configured to select one of the plurality of table candidates that search time is short.

3. The packet processing apparatus according to claim 1, wherein the processing unit is configured to use a first table as the table before reception of the request for addition, and the packet processing apparatus further comprises a management unit configured to generate the table selected from the plurality of table candidates as a second table used for search by the processing unit when a type of the table selected from the plurality of table candidates is different from a type of the first table.

4. The packet processing apparatus according to claim 3, wherein the management unit is configured to add the new entry to the first table when the type of the table selected and the type of the first table are the same.

5. The packet processing apparatus according to claim 3, wherein the management unit is configured to exchange the first table for the second table.

6. The packet processing apparatus according to claim 3, wherein the management unit is configured to arrange the second table at a previous stage or a next stage of the first table.

7. The packet processing apparatus according to claim 1, further comprising a storage unit is configured to store a table type, a number of entries, and a search time which are associated with one another,
wherein the selection unit is configured to read out a search time corresponding to the type and the number of entries of each of the plurality of table candidates and is configured to compare the search times to select one of the plurality of table candidates.

8. The packet processing apparatus according to claim 7, further comprising an accumulation unit is configured to associate a type of a table used when the processing unit performs a search related to a received packet and a number of pieces of identification information for a packet stored in the table used for the search related to the received packet with a search time required for the search related to the received packet, and is configured to store them a storage device.

9. The packet processing apparatus according to claim 8, wherein:
the selection unit is configured to select a first candidate that a search time corresponding to a type of table and a number of pieces of identification information for a packet is not stored in the storage device when the plurality of table candidates include the first candidate;
the management unit is configured to generate a table corresponding to the first candidate; and
the accumulation unit is configured to store a type of the table corresponding to the first candidate, a number of pieces of identification information for a packet stored in the table corresponding to the first candidate, and a time required for search using the table corresponding to the first candidate in the storage device when the accumulation unit performs the search using the table corresponding to the first candidate.

10. A method of selecting a table, comprises:
searching for, using a processor, a process corresponding to a piece of packet identification information of a received packet from a table including apiece of information indicating a process corresponding to a piece of packet identification information:
acquiring, using the processor, a plurality of table candidates that have different types and in which all packets identified by a new piece of identification information for a packet and an existing piece of identification information for a packet are retrievable from the plurality of table candidates, based on the existing piece of packet identification information and the new piece of packet identification information when a request for addition of a new entry including the new piece of identification information for a packet is received; and
selecting, using the processor, a table used for the searching from among the plurality of table candidates based on a number of pieces of packet identification information stored in each of the plurality of table candidates.
